(19) United States
(12) Patent Application Publication
(10) Pub. No.: US 2021/0334646 A1
(43) Pub. Date: Oct. 28, 2021

(54) ROBUSTNESS-AWARE QUANTIZATION FOR NEURAL NETWORKS AGAINST WEIGHT PERTURBATIONS

(71) Applicant: International Business Machines Corporation, Armonk, NY (US)

(72) Inventors: Sijia Liu, Somerville, MA (US); Pin-Yu Chen, White Plains, NY (US); Gaoyuan Zhang, Medford, MA (US); Chuang Gan, Cambridge, MA (US)

(21) Appl. No.: 16/861,019

(22) Filed: Apr. 28, 2020

(51) Int. Cl. G06N 3/08; G06N 20/00; G06F 17/18

(52) U.S. Cl. CPC G06N 3/08; G06F 17/18; G06N 20/00

(57) ABSTRACT

A method of utilizing a computing device to optimize weights within a neural network to avoid adversarial attacks includes receiving, by a computing device, a neural network for optimization. The method further includes determining, by the computing device, on a region by region basis one or more robustness bounds for weights within the neural network. The robustness bounds indicating values beyond which the neural network generates an erroneous output upon performing an adversarial attack on the neural network. The computing device further averages all robustness bounds on the region by region basis. The computing device additionally optimizes weights for adversarial proofing the neural network based at least in part on the averaged robustness bounds.

### STATEMENT REGARDING PRIOR DISCLOSURES BY THE INVENTOR OR A JOINT INVENTOR

The following disclosure is submitted under 35 U.S.C. 102(b)(1)(A): DISCLOSURE: Towards Certificated Model Robustness Against Weight Perturbations, Tsui-Wei Weng, Pu Zhao, Sijia Liu, Pin-Yu Chen, Xue Lin and Luca Daniel, Feb. 16, 2020, Association for the Advancement of Artificial Intelligence, Hilton New York Midtown, New York, N.Y.

### BACKGROUND

The field of embodiments of the present invention relates to robustness for neural networks in view of weight perturbation.

Although deep neural networks (DNNs) have achieved human-level performance in many learning tasks, recent works made the discovery of adversarial examples against DNNs. Conventional studies have researched implementing adversarial attacks in various applications and defense methods. There also exist weight perturbations in the non-adversarial setting. For example, weight quantization, a major DNN model compression technique commonly utilized by industry for DNN acceleration/implementation, induces weight perturbations by replacing full floating-point precision weights with fixed-point lower precision weights. Direct mapping from full precision weights of DNNS into quantized weights could result in significant generalization errors.

### SUMMARY

Embodiments relate to robustness-aware quantization processing for neural networks (NNs) against weight perturbations. One embodiment provides a method of utilizing a computing device to optimize weights within a NN to avoid adversarial attacks. The method includes receiving, by a computing device, a neural network for optimization. The method further includes determining, by the computing device, on a region by region basis one or more robustness bounds for weights within the neural network. The robustness bounds indicating values beyond which the neural network generates an erroneous output upon performing an adversarial attack on the neural network. The computing device further averages all robustness bounds on the region by region basis. The computing device additionally optimizes weights for adversarial proofing the neural network based at least in part on the averaged robustness bounds. In some embodiments, the above features contribute to the advantage of providing efficient processing for computing a certified robustness bound, in terms of a certified weight perturbation region, within which the weight-perturbed networks will not make erroneous outputs. For non-adversarial NNs, the above-features provide for a weight quantization scheme that leverages the knowledge on certified robustness. The embodiments significantly improve the generalization ability of quantized neural networks. For adversarial environments, some features contribute to the advantage of providing a robustness indicator of neural networks when facing weight-perturbation based adversarial attacks.

One or more of the following features may be included. In some embodiments, the robustness bounds comprise a certified weight perturbation region such that the neural network maintains a prediction accuracy upon weight parameter perturbation occurring within the certified weight perturbation region.

In some embodiments, averaging further includes determining, by the computing device, a certified weight perturbation region for multiple inputs such that the neural network maintains a prediction accuracy upon weight parameter perturbation occurring within the certified weight perturbation region.

In one or more embodiments, the method may further include determining, by the computing device, a maximum perturbation radius such that an optimal objective value is positive.

In some embodiments, the method may additionally include applying, by the computing device, certificate-aware weight perturbation constraints based on the averaged robustness bounds in quantization design of the neural network.

In one or more embodiments, the method may include training, by the computing device, the neural network using alternating direction method of multipliers (ADMM) and incorporating the certificate-aware weight perturbation constraints, wherein the neural network is a quantized deep neural network.

In some embodiments, the method may further include discretizing, by the computing device, model weights for the neural network based on a finite number of bits while preserving the machine learning model output prediction accuracy.

In one or more embodiments, the method may additionally include propagating, by the computing device, the averaged robustness bounds throughout a plurality of neurons in the neural network.

These and other features, aspects and advantages of the present embodiments will become understood with reference to the following description, appended claims and accompanying figures.

### BRIEF DESCRIPTION OF THE DRAWINGS

FIG. 1 depicts a cloud computing environment, according to an embodiment;

FIG. 2 depicts a set of abstraction model layers, according to an embodiment;

FIG. 3 is a network architecture of a system for robustness-aware quantization processing for neural networks (NNs) against weight perturbations, according to an embodiment;

FIG. 4 shows a representative hardware environment that may be associated with the servers and/or clients of FIG. 1, according to an embodiment;

FIG. 5 is a block diagram illustrating a distributed system for robustness-aware quantization processing for NNs against weight perturbations, according to one embodiment;

FIG. 6 shows an example of quantization introducing weight perturbation for a NN;

FIG. 7 shows an example of prediction without quantization for a NN;

FIG. 8 shows an example of prediction with quantization and activated weight perturbation with an example certification for robustness, according to one embodiment;

FIG. 9 illustrates a block diagram of a flow for robustness-aware quantization processing for NNs against weight perturbations, according to one embodiment;

FIG. 10 illustrates a graph for testing accuracy of quantized 8-layer multi-layer perceptron (MLP) on the street view house numbers (SVHN) dataset versus certification constraints, according to one embodiment;

FIG. 11A shows a graph for training/testing accuracy of quantization with/without certification constraints for the Fashion Modified National Institute of Standards and Technology (MNIST) database (MNIST-Fashion), according to one embodiment;

FIG. 11B shows a graph for training/testing accuracy of quantization with/without certification constraints for the SVHN dataset, according to one embodiment;

FIG. 11C shows a legend for the graphs of FIGS. 11A-B, according to one embodiment;

FIG. 12 shows a graph for test accuracy degradation after perturbing each layer of a model using a fault injection attack, according to one embodiment; and

FIG. 13 illustrates a block diagram of a process for robustness-aware quantization processing for NNs against weight perturbations, according to one embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to robustness-aware quantization processing for neural networks (NNs) against weight perturbations. One embodiment provides a method of utilizing a computing device to optimize weights within a NN to avoid adversarial attacks. The method includes receiving, by a computing device, a NN for optimization. The method further includes determining, by the computing device, on a region by region basis one or more robustness bounds for weights within the NN. The robustness bounds indicating values beyond which the NN generates an erroneous output upon performing an adversarial attack on the NN. The computing device further averages all robustness bounds on the region by region basis. The computing device additionally optimizes weights for adversarial proofing the NN based at least in part on the averaged robustness bounds. The method may further include that robustness bounds include a certified weight perturbation region such that the NN maintains a prediction accuracy upon weight parameter perturbation occurring within the certified weight perturbation region. The method may additionally include determining, by the computing device, a certified weight perturbation region for multiple inputs such that the NN maintains a prediction accuracy upon weight parameter perturbation occurring within the certified weight perturbation region. In some embodiments, the method may include determining, by the computing device, a maximum perturbation radius such that an optimal objective value is positive. In some embodiments, the method may additionally include applying, by the computing device, certificate-aware weight perturbation constraints based on the averaged robustness bounds in quantization design of the NN. In one or more embodiments, the method may include training, by the computing device, the NN using alternating direction method of multipliers (ADMM) and incorporating the certificate-aware weight perturbation constraints, wherein the NN is a quantized deep NN. In some embodiments, the method may further include discretizing, by the computing device, model weights for the NN based on a finite number of bits while preserving the machine learning model output prediction accuracy. In one or more embodiments, the method may additionally include propagating, by the computing device, the averaged robustness bounds throughout a plurality of neurons in the NN.

Artificial intelligence (AI) models may include a trained ML model (e.g., models, such as a NN, a convolutional NN (CNN), a recurrent NN (RNN), a Long short-term memory (LSTM) based NN, gate recurrent unit (GRU) based RNN, tree-based CNN, self-attention network (e.g., an NN that utilizes the attention mechanism as the basic building block; self-attention networks have been shown to be effective for sequence modeling tasks, while having no recurrence or convolutions), BiLSTM (bi-directional LSTM), etc.). An artificial NN is an interconnected group of nodes or neurons.

Different from the robustness issue caused by input perturbations, weight perturbations focus on deep NN (DNN) models for natural (unperturbed) examples rather than adversarial examples. If training and testing sample stem from the same distribution, evaluating the model robustness against weight perturbations in the training dataset (namely, sensitivity of training accuracy to weight perturbations) is able to provide informative guidelines in the generalization ability of the weight-perturbed network (e. g., weight-quantized network).

Embodiments relate to the sensitivity of NNs to weight perturbations, firstly corresponding to a threat model through perturbing weights. One embodiment includes an efficient approach to compute a certified robustness bound of weight perturbations, within which NNs will not make erroneous outputs as desired by the adversary. :Furthermore, based on the developed certification process, the problem of weight quantization is revisited, a major model compression technique in DNNs and a “must try” step in the design of DNN inference engines on resource constrained computing platforms, such as mobile electronic devices, field-programmable gate arrays (FPGA) and application-specific integrated circuits (ASICs). The problem of weight quantization—weight perturbations in the non-adversarial setting—through the lens of certificated robustness. Significant improvements on the generalization ability of quantized networks are achieved through a robustness-aware quantization scheme.

It is understood in advance that although this disclosure includes a detailed description of cloud computing, implementation of the teachings recited herein are not limited to a cloud computing environment. Rather, embodiments of the present embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

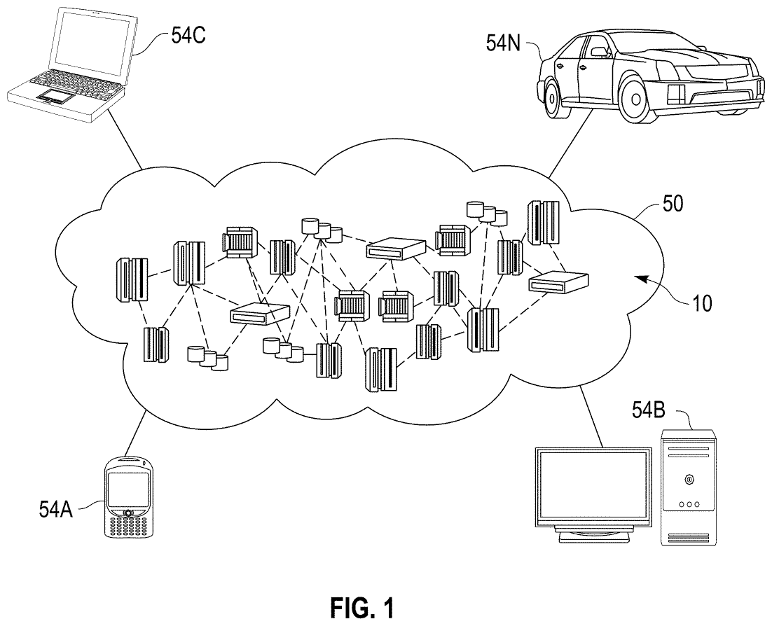

Referring now to FIG. 1, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

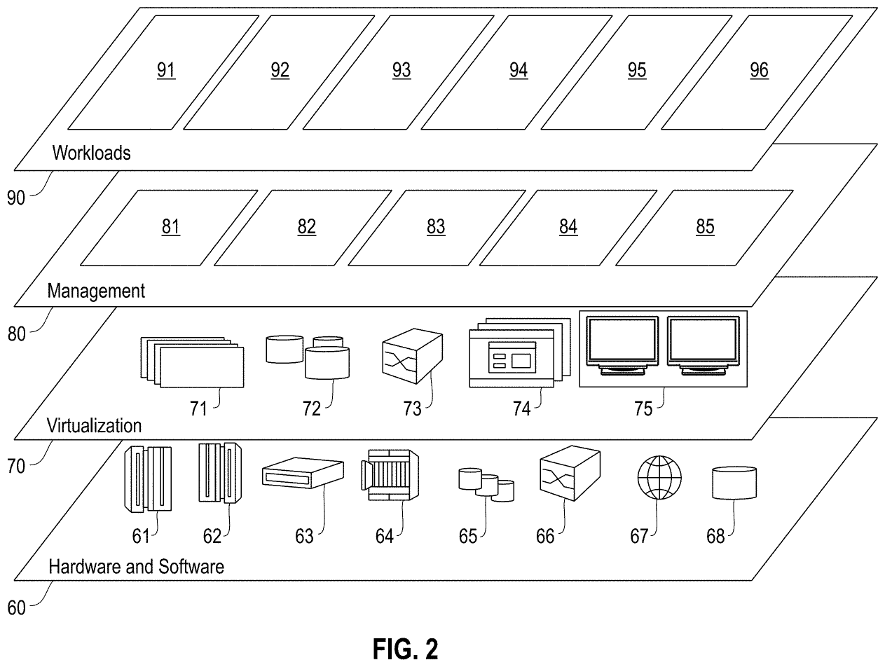

Referring now to FIG. 2, a set of functional abstraction layers provided by the cloud computing environment 50 (FIG. 1) is shown. It should be understood in advance that the components, layers, and functions shown in FIG. 2 are intended to be illustrative only and embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

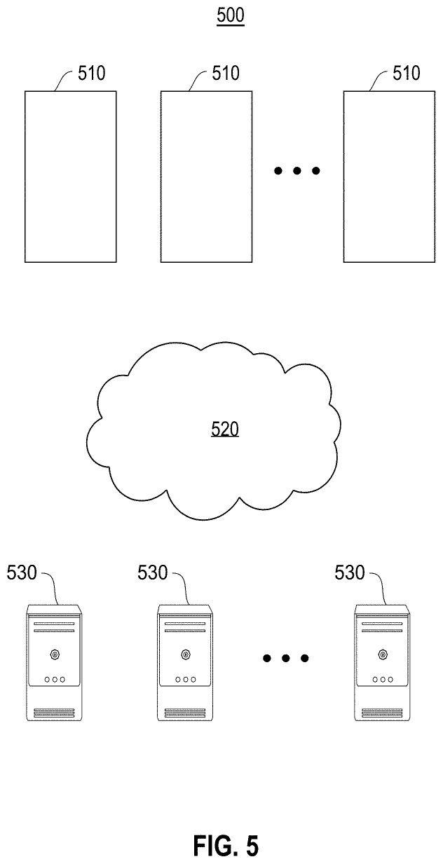

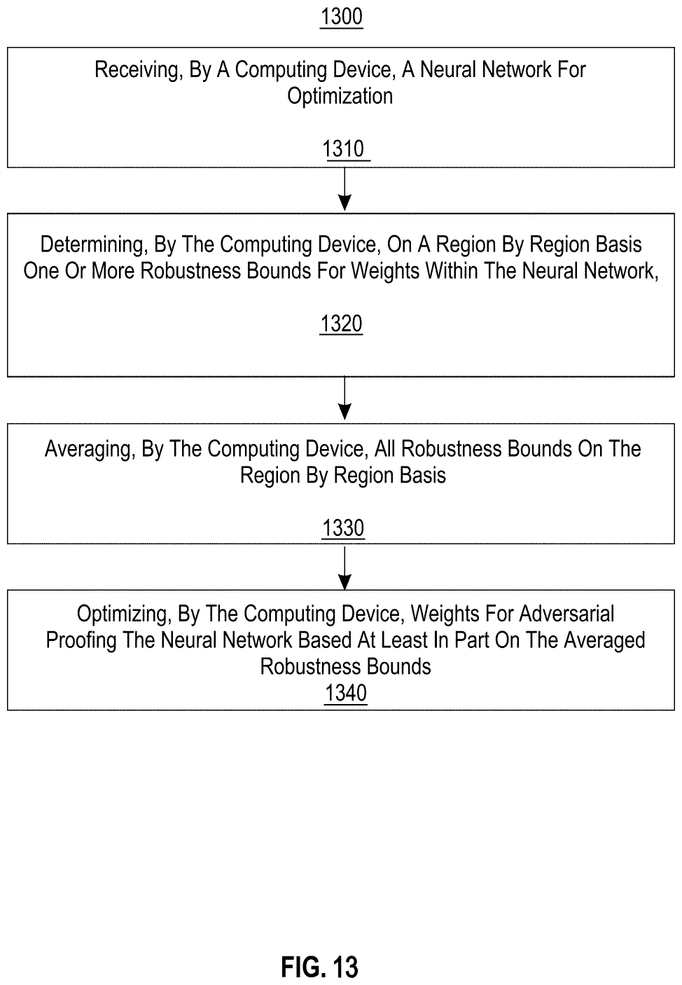

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and for robustness-aware quantization for NNs against weight perturbations processing 96 (see, e.g., system 500, FIG. 5 and process 1300, FIG. 13). As mentioned above, all of the foregoing examples described with respect to FIG. 2 are illustrative only, and the embodiments are not limited to these examples.

It is reiterated that although this disclosure includes a detailed description on cloud computing, implementation of the teachings recited herein are not limited to a cloud computing environment. Rather, the embodiments may be implemented with any type of clustered computing environment now known or later developed.

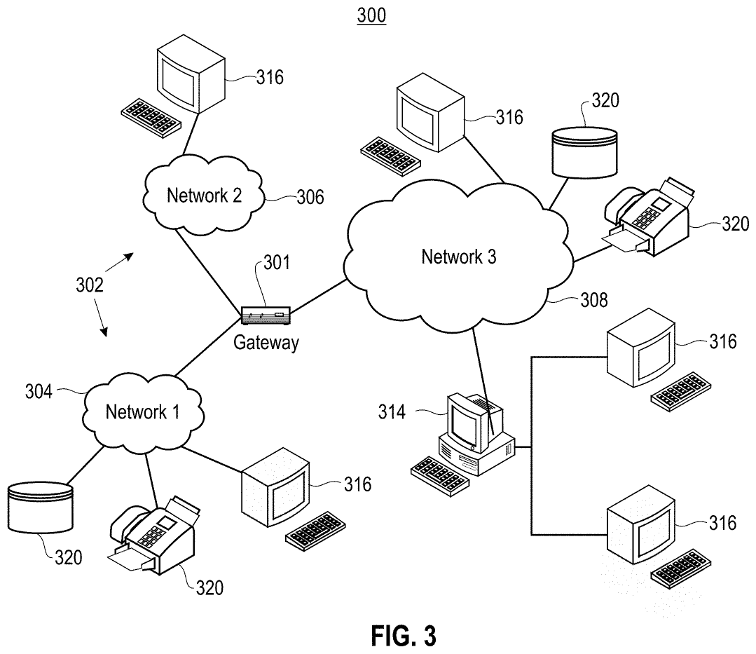

FIG. 3 is a network architecture of a system 300 for robustness-aware quantization for NNs against weight perturbations processing, according to an embodiment. As shown in FIG. 3, a plurality of remote networks 302 are provided, including a first remote network 304 and a second remote network 306. A gateway 301 may be coupled between the remote networks 302 and a proximate network 308. In the context of the present network architecture 300, the networks 304, 306 may each take any form including, but not limited to, a LAN, a WAN, such as the Internet, public switched telephone network (PSTN), internal telephone network, etc.

In use, the gateway 301 serves as an entrance point from the remote networks 302 to the proximate network 308. As such, the gateway 301 may function as a router, which is capable of directing a given packet of data that arrives at the gateway 301, and a switch, which furnishes the actual path in and out of the gateway 301 for a given packet.

Further included is at least one data server 314 coupled to the proximate network 308, which is accessible from the remote networks 302 via the gateway 301. It should be noted that the data server(s) 314 may include any type of computing device/groupware. Coupled to each data server 314 is a plurality of user devices 316. Such user devices 316 may include a desktop computer, laptop computer, handheld computer, printer, and/or any other type of logic-containing device. It should be noted that a user device 316 may also be directly coupled to any of the networks in some embodiments.

A peripheral 320 or series of peripherals 320, e.g., facsimile machines, printers, scanners, hard disk drives, networked and/or local storage units or systems, etc., may be coupled to one or more of the networks 304, 306, 308. It should be noted that databases and/or additional components may be utilized with, or integrated into, any type of network element coupled to the networks 304, 306, 308. In the context of the present description, a network element may refer to any component of a network.

According to some approaches, methods and systems described herein may be implemented with and/or on virtual systems and/or systems, which emulate one or more other systems, such as a UNIX® system that emulates an IBM® z/OS environment, a UNIX® system that virtually hosts a MICROSOFT® WINDOWS® environment, a MICROSOFT® WINDOWS® system that emulates an IBM® z/OS environment, etc. This virtualization and/or emulation may be implemented through the use of VMWARE° software in some embodiments.

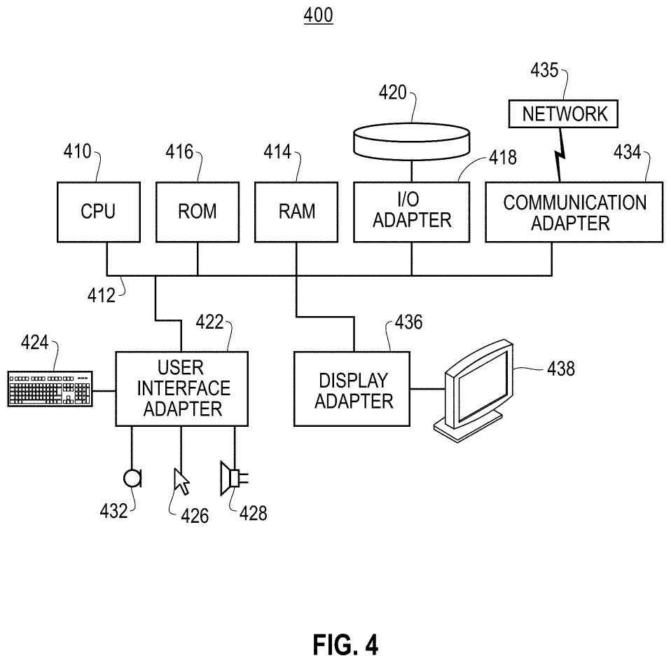

FIG. 4 shows a representative hardware system 400 environment associated with a user device 316 and/or server 314 of FIG. 3, in accordance with one embodiment. In one example, a hardware configuration includes a workstation having a central processing unit 410, such as a microprocessor, and a number of other units interconnected via a system bus 412. The workstation shown in FIG. 4 may include a Random Access Memory (RAM) 414, Read Only Memory (ROM) 416, an I/O adapter 418 for connecting peripheral devices, such as disk storage units 420 to the bus 412, a user interface adapter 422 for connecting a keyboard 424, a mouse 426, a speaker 428, a microphone 432, and/or other user interface devices, such as a touch screen, a digital camera (not shown), etc., to the bus 412, communication adapter 434 for connecting the workstation to a communication network 435 (e.g., a data processing network) and a display adapter 436 for connecting the bus 412 to a display device 438.

In one example, the workstation may have resident thereon an operating system, such as the MICROSOFT® WINDOWS® Operating System (OS), a MAC OS®, a UNIX® OS, etc. In one embodiment, the system 400 employs a POSIX® based file system. It will be appreciated that other examples may also be implemented on platforms and operating systems other than those mentioned. Such other examples may include operating systems written using JAVA®, XML, C, and/or C++ language, or other programming languages, along with an object oriented programming methodology. Object oriented programming (OOP), which has become increasingly used to develop complex applications, may also be used.

FIG. 5 is a block diagram illustrating a distributed system 500 for robustness-aware quantization processing for NNs against weight perturbations processing, according to one embodiment. In one embodiment, the system 500 includes client devices 510 (e.g., mobile devices, smart devices, computing systems, etc.), a cloud or resource sharing environment 520 (e.g., a public cloud computing environment, a private cloud computing environment, a data center, etc.), and servers 530. In one embodiment, the client devices 510 are provided with cloud services from the servers 530 through the cloud or resource sharing environment 520.

Although DNNs have achieved human-level performance in many learning tasks, adversarial examples against DNNs exist. An ever-increasing amount of research effort has been devoted to implementing adversarial attacks in various applications, and defense methods ranging from heuristic methods to provable approaches with a certain robustness certificate. Distinguishable from the conventional methods on the well-studied problem of robustness against input perturbations, embodiments relate to evaluating the sensitivity of DNNs to weight perturbations.

Weight perturbations of DNNs are of realistic significance. A conventional threat model of weight perturbations showed that the so-called fault sneaking/injection attack can enforce a DNN to misclassify some natural input images into target labels by slightly modifying weights at a single layer, while maintaining the classification of unspecified input images intact. This implies that the outputs of DNNs are also sensitive to weight perturbations. Moreover, conventional methods exist for weight perturbations in the non-adversarial setting. For example, weight quantization, a DNN model compression technique commonly utilized by industry for DNN acceleration/implementation, induces weight perturbations by replacing full floating-point precision weights with fixed-point lower precision weights. Direct mapping from full precision weights of DNNs into quantized weights could result in significant generalization error.

Distinguishable from the robustness issue caused by input perturbations, weight perturbations focus on DNN models for natural (unperturbed) examples rather than adversarial examples. If training and testing samples stem from the same distribution, evaluating the model robustness against weight perturbations in the training dataset (namely, sensitivity of training accuracy to weight perturbations) is able to provide informative guidelines on the generalization ability of the weight-perturbed network (e.g., weight-quantized network).

In some embodiments, the certificate problem of model robustness against weight perturbations is addressed. Embodiments provide a solution to this problem that includes providing a certified weight perturbation region such that DNNs maintain the accuracy if weight perturbations are within that region. Additionaly, provable and non-trivial lower bounds on the exact certified weight perturbation region are determined in two scenarios: a) single-layer perturbation and b) multi-layer perturbation. The certified lower bound provides a reasonable assessment on the practical robustness of a model against a fault injection attack. Further, embodiments provide a design of weight quantization by leveraging the statistics obtained from the certified weight perturbation region. This leads to a robust-aware quantization scheme, that can be efficiently achieved via an alternating direction method of multipliers (ADMM). The resulting quantized network yields a significant improvement on its generalization ability compared to conventional quantization methods, which neglect the effect of weight perturbations on the training procedure.

Unless specified otherwise, the following notations are used herein. Let (x, c) denote a pair of example x and class label c. For a K-layer NN, let nₖW^{(k)} ∈ [symbol] ⁿ^{ₖ}^{×n}^{_{k−1}}, b^{(k)} ∈ [symbol] ⁿ^{ₖ} denote the number of neurons, the weight matrix and the bias vector at layer k, respectively. The superscript (k) is used to indicate the variable associated with layer k. W and b are defined herein as W:={W^{(k)}}ₖ₌₁^{L} and b:={b^{(k)}}ₖ₌₁^{K} and are used to denote the vector/matrix/set containing all variables indexed by k. And [K] is used to denote the integer set {1,2, . . . K}. Let f(x; W, b) ∈ [symbol] ⁿ^{_{K}} be a NN function with respect to the input x for n_{K} output classes. Here f is referred to as the logit layer. The softmax layer can be safely discarded in the analysis due to its monotonicity. The following is used, fⱼ(x; W, b) (or simply fⱼ) to denote the j-th class output of the NN. Let \tilde{Φ}^{(k)} (x) ∈ [symbol] ⁿ^{ₖ} and Φ^{(k)} (x) ∈ [symbol] ⁿ^{ₖ} denote the pre-activation and post-activation values of the k-th layer, respectively. And let σ(⋅) denote a non-linear element-wise activation function.

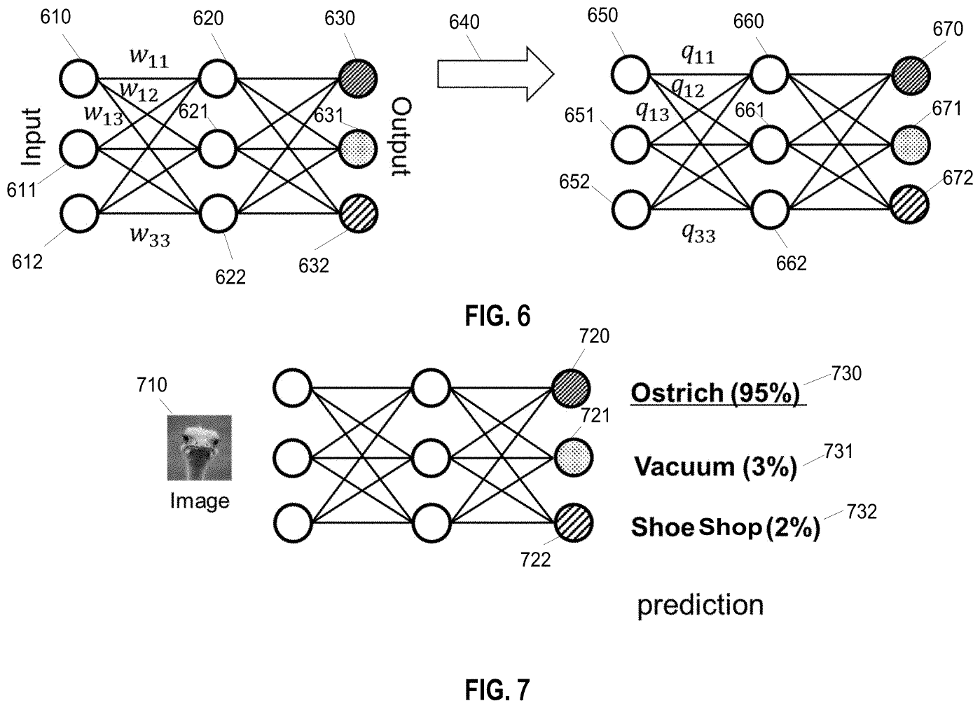

FIG. 6 shows an example of quantization introducing weight perturbation for a NN. In this example, the input is applied to neurons 610, 611 and 612 of the NN on the left. The weights w₁₁, w₁₂, w₁₃ to w₃₃) are applied to the interim neurons (neurons 620, 621 and 622). The output neurons are neurons 630, 631 and 632. Quantization 640 is applied as qᵢⱼ=Q(wᵢⱼ) (e.g., sign (wᵢⱼ). The NN on the right of FIG. 6 has input neurons 650, 651 and 652, quantization q₁₁, q₁₂, q₁₃ to q₃₃, interim neurons 660, 661 and 662 and output neurons 670, 671 and 672. The quantization 640 introduces weight perturbation |qᵢⱼ−wᵢⱼ|.In some embodiments, the focus is on the K-layer fully-connected (FC) feedforward NN with rectified linear unit (ReLU) activation functions but the results can also be generalized to CNNs and general activations. The input-output relationship of the network is given by the following:

Φ^{(k)}(x)=σ(\tilde{Φ}^{(k)}(x)),

\tilde{Φ}^{(k)}(x)=W^{(k)}Φ^{(k-1)}(x)+b^{(k)}, k ∈ [K], Eq. (1)

where Φ⁽⁰⁾(x):=x, and f(x; W, b)=Φ^{(K)}(x). In the classification setting, the predicted class c is the class that has the largest output value: arg maxⱼfⱼ.

In one embodiment, the problem at interest is to provide a robustness certificate for a NN when its weight parameters are perturbed. Norm based weight perturbations [symbol] _{∞}—are defined as

[symbol]

(W, ∈)={Ŵ|Ŵ={Ŵ^{(k)}},

∥Ŵ^{(k)}−W^{(k)} ∥_{∞}≤∈, ∀k ∈ [K]}, Eq. (2)

where ∈ is the perturbation radius, and Ŵ^{(k)} denotes the perturbed weights against the original weights W^{(k)} at each layer. Given ∈, verifying the neural network robustness (at input x with the true label c) against weight perturbation is cast as the following optimization problem

$$minimize {f}_{c} ( \hat{W} ) - {max}_{j \neq c} {f}_{j} ( \hat{W} ) \\ \hat{W} \\ subject to \hat{W} ∈ ℬ ( W , ϵ ) , \qquad Eq . ( 3 )$$

where the simplified notation fⱼ(W) is used to highlight the dependency of classification on model weights by omitting x and b. If the optimal value of Eq. (3) is positive, then the robustness of the NN is certified under E-tolerant weight perturbation at input x.

In one embodiment, a goal of robustness certification under weight perturbation involves finding the largest ∈ such that Eq. (3) has a positive optimal value. Similar as conventional techniques, it is noted that Eq. (3) maintains the similar formulation of verifying an NN's robustness against input perturbation. However, none of the conventional techniques considered the direction of certifying robustness against weight perturbation as one or more embodiments. Distinguishable from the input perturbation that generates an adversarial example, the effect of weight perturbation on network robustness is measured under the original input. At this sense, the certified perturbation region in terms of E in Eq. (3) offers the new perspective on how sensitive the prediction accuracy of a well-trained network could be against weight perturbation. Moreover, since weights can be perturbed at multiple layers, the problem of weight perturbation suffers from a more complicated layer-wise coupling issue than the problem of certifying input perturbation.

FIG. 7 shows an example of prediction without quantization for a NN. In this example, the input is an image 710 of an ostrich. The output neuron 720 includes a prediction 730 of the image being an ostrich as 95%. The output neuron 721 includes a prediction 731 of the image being a vacuum as 3%. The output neuron 722 includes a prediction 732 of the image being a shoe shop as 2%. Some embodiments address the certificate problem of model robustness against weight perturbations. In one embodiment, the solution to this problem provides the certified weight perturbation region such that DNNs maintain the accuracy if weight perturbations are within that region.

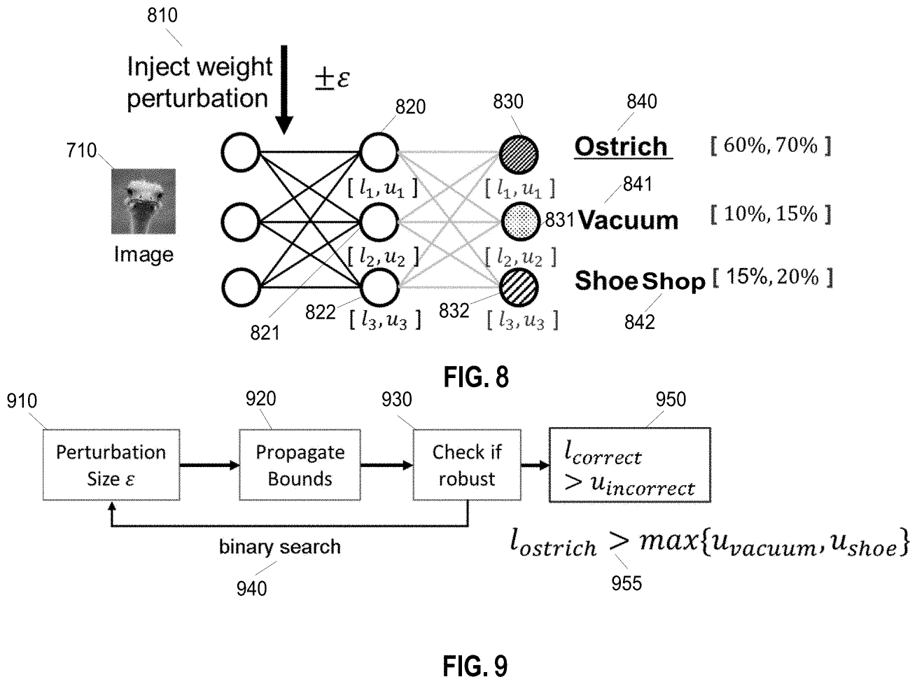

FIG. 8 shows an example of prediction with quantization and activated weight perturbation with an example certification for robustness, according to one embodiment. In this example embodiment, a process injects weight perturbation 810 to the NN. The input 710 is the same as in FIG. 7. The intermediate neuron 820 is bounded by [I₁, u₁] as is the output neuron 830, which is [60%, 70%] for a prediction of ostrich 840. The intermediate neuron 821 is bounded by [l₂, u₂] as is the output neuron 831, which is [10%, 15%] for a prediction of vacuum 841. The intermediate neuron 822 is bounded by [l₃, u₃] as is the output neuron 832, which is [15%, 20%] for a prediction of shoe shop 842. In one embodiment, prediction with quantization and activated weight perturbation with certification for robustness is processed (e.g., using a computing device such as from computing node 10, FIG. 1, hardware and software layer 60, FIG. 2, processing system 300, FIG. 3, system 400, FIG. 4, system 500, FIG. 5, etc.) by: given input x (e.g., image 710, etc.), determine a certified weight perturbation region (e.g., [lᵢ, uⱼ]) such that the DNN will maintain prediction accuracy if the perturbation is within that region. This is performed for multiple inputs/nodes, and the averaged layer-wise weight perturbation tolerance is computed. Based on the averaged layer-wise weight perturbation tolerance, the certificate-constrained weight quantization design is provided.

FIG. 9 illustrates a block diagram of a high-level flow for robustness-aware quantization processing for NNs against weight perturbations, according to one embodiment. In one embodiment, in block 910 the perturbation size ∈ is injected by a computing device (e.g., computing node 10, FIG. 1, hardware and software layer 60, FIG. 2, processing system 300, FIG. 3, system 400, FIG. 4, system 500, FIG. 5, etc.) by: given input x (e.g., image 710, etc.). In block 920 a weight perturbation region or bounds is propagated in the example DNN. In block 930, the weight perturbation region is checked for robustness. If the determination of robustness results in not meeting a threshold, the flow proceeds to perform a binary search at 940. Otherwise, l_{correct} is greater than u_{incorrect} at block 950. For the example in FIG. 8, this results in l_{ostrich}>max{u_{vacuum}, u_{shoe (shop)}} 955. This processing is described in further detail below.

In one embodiment, a certified lower bound is described below when the weights of NNs are perturbed. A simple 2-layer multi-layer perceptron (MLP) example is provided as well as general results. Additionally, the results are generalized to the MLP setting. An MLP is a deep, artificial NN that is composed of more than one perceptron (a linear classifier (an algorithm or process) that classifies input by separating two categories with a straight line; a perceptron produces a single output based on several real-valued inputs by forming a linear combination using its input weights (and sometimes passing the output through a nonlinear activation function). MLPs are composed of an input layer to receive the signal, an output layer that makes a decision or prediction about the input, and in between those two, an arbitrary number of hidden layers that are the true computational engine of the MLP. MLPs with one hidden layer are capable of approximating any continuous function. When the weight perturbation only occurs at a single layer (e.g., the N-th layer, N≤K), the following constraint results:

∥Ŵ^{(N)}−W^{(N)} ∥_{∞}≤∈, Ŵ^{(k)}=W^{(k)}, ifk≠N, k ∈ [K]. Eq. (4)

Ideally, it is desired to solve Eq. (3) exactly to get the maximum possible (exact) tolerance E on the weight perturbation such that the top-1 prediction of a NN classifier will not change. However, it has been shown that there does not exist a polynomial time algorithm to compute the exact robustness of NNs. Hence, a goal is to find a non-trivial E efficiently and this problem can be formulated as follows.
Let _{c}^{L}(Ŵ) and f_{c}^{U}(Ŵ) be two linear functions of Ŵ such that f_{c}^{L}(Ŵ)≤f_{c}(Ŵ)≤f_{c}^{U}(Ŵ) for all Ŵ, and let

$${γ}_{c}^{L} = {min}_{\hat{W} ∈ ℬ ( W , ϵ )} {f}_{c}^{L} ( \hat{W} ) , {γ}_{c}^{U} = {max}_{\hat{W} ∈ ℬ ( W , ϵ )} {F}_{c}^{U} ( \hat{W} ) . \qquad Eq . ( 5 )$$

Computation of E may be obtained by solving the following optimization equation:

$$maximize ϵ \\ ϵ subject to {γ}_{c}^{L} - {γ}_{j}^{U} > 0 , ∀ j \neq c . \qquad Eq . ( 6 )$$

It should be noted that the constraint set γ_{c}^{L}−max_{j≠c}γⱼ^{U}>0 (namely, γ_{c}^{L}−γⱼ^{U}>0, ∀j≠c) is more restricted than f_{c}(Ŵ)−max_{j≠c}fⱼ(Ŵ)>0. Thus, the solution to Eq. (6) provides a certified lower bound on the maximum ∈ to ensure the positive objective value of Eq. (3). In fact, in the following description, it will be shown that γ_{c}^{L} and γ_{c}^{U} can be computed analytically, and hence the solution of Eq. (6) may be found efficiently through bi-section on ∈. It should be noted that the focus here is on weight-perturbation on the NNs and to show that it is also possible to derive a certified lower bound for this problem setting.

In one embodiment, let NN f be bounded by two linear functions f_{c}^{L}(Ŵ) and f_{c}^{U}(Ŵ). In some embodiments, the linear bounds f_{c}^{L}(Ŵ), f_{c}^{U}(Ŵ) of a K-layer feed-forward NN f are derived by applying linear upper and lower bounds on each neuron's activation and consider the signs of associated weights. In one embodiment, the derivation begins with a 2-layer NN (K=2) and then extending it to the general case. Suppose that the first layer weights are perturbed, then for Eq. (4): K=1. The j-th output of the NN (with respect to Ŵ⁽¹⁾) is then given by

fⱼ(Ŵ⁽¹⁾)=Σ_{r∈[n}_{¹}_{]}W_{j,r}⁽²⁾σ(Ŵ_{r,:}⁽¹⁾x+bᵣ⁽¹⁾)+bⱼ⁽²⁾, Eq. (7)

where W_{j,r} denotes the (j, r)-th entry of W, and Ŵ_{r,:} denotes the r-th row of Ŵ. Since W_{r,:}⁽¹⁾−∈≤Ŵ_{r,:}⁽¹⁾≤W_{r,:}⁽¹⁾+∈, the pre-activation yᵣ⁽¹⁾:=Ŵ_{r,:}⁽¹⁾x+bᵣ⁽¹⁾ at the 1-st layer is bounded by some constants lᵣ^{(1), and u}ᵣ⁽¹⁾, which are determined by the signs of x and the bounds of Ŵ_{r.,}⁽¹⁾. Given yᵣ⁽¹⁾ ∈ [lᵣ⁽¹⁾, uᵣ⁽¹⁾], the non-linear activation function σ(yᵣ⁽¹⁾) has explicit linear bounds with slope and bias parameters {α_{L,r}⁽¹⁾, α_{U,r}⁽¹⁾} and {β_{L,r}⁽¹⁾, β_{U,r}⁽¹⁾} as follows:

α_{L,r}⁽¹⁾(yᵣ⁽¹⁾+β_{L,r}⁽¹⁾)≤σ(yᵣ⁽¹⁾)≤α_{U,r}⁽¹⁾(yᵣ⁽¹⁾+β_{U,r}⁽¹⁾). Eq. (8)

If lᵣ⁽¹⁾>0>uᵣ⁽¹⁾, then

$${α}_{L , r}^{( 1 )} = {α}_{U , r}^{( 1 )} = \frac{{u}_{r}^{( 1 )}}{{u}_{r}^{( 1 )} - {l}_{r}^{( 1 )}} ,$$

β_{L,r}⁽¹⁾=0, and β_{U,r}⁽¹⁾=−lᵣ⁽¹⁾; if lᵣ⁽¹⁾≤uᵣ⁽¹⁾≤0, then all parameters are zeros; if 0≤lᵣ^{(1)≤u}ᵣ⁽¹⁾, then α_{L,r}^{(1) =α}_{U,r}⁽¹⁾=1 and β_{L,r}⁽¹⁾=β_{U,r}⁽¹⁾=0. The Eqs. (7) and (8) of the 2-layer NN example imply two general rules:

1. The pre-activation bounds at the N-th layer are known a priori (since no weight prior to the N-th layer is perturbed), and thus it is only necessary to perform bound propagation processing for k>N layers; and

2. The final layer bounds f_{c}^{L}(Ŵ) and f_{c}^{u}(Ŵ) are computed via bound propagation. The pre-activation bounds are computed layer by layer (which is referred to as bound propagation) analytically via the theorem described below. The analysis (or theorem) below shows the analytic output bounds of NNs when there exists single-layer 4 [symbol] ₚ-norm weight perturbation with p≥1.

For some embodiments, suppose that the N-th layer weights are perturbed in a K-layer NN. Let f: [symbol] ⁿ^{_{N}}^{×n}^{_{N−1}}→ [symbol] ⁿ^{_{K}} denote the mapping from perturbed weights Ŵ^{(N)} at the single layer N to predicted outputs at the final layer K. Then two explicit functions exist: fⱼ^{L}: [symbol] ⁿ^{_{N−1}}→ [symbol] and fⱼ^{U}: [symbol] ⁿ^{_{N}}^{×n}^{_{N−1}}→ [symbol] for class ∀j ∈ [n_{K}], such that the following inequality holds:

fⱼ^{L}(Ŵ^{(N)})≤fⱼ(Ŵ^{(N)})≤fⱼ^{U}(Ŵ^{(N)}), Eq. (9)

where ∥Ŵ_{s,:}^{(N)}−W_{s,:}^{(N)} ∥ₚ≤∈ and Ŵ^{(k)}=W^{(k)} for ∀k≠N, and p≤1. The closed forms of lower and upper bounds in Eq. (9) are given by

$$\begin{matrix}{f}_{j}^{U} ( {\hat{W}}^{( N )} ) = {Λ}_{j , :}^{( N - 1 )} {\hat{W}}^{( N )} {Φ}^{( N - 1 )} ( x ) + {\sum }_{k = N}^{K} {Λ}_{j , :}^{( k )} ( {b}^{( k )} + {Δ}_{: , j}^{( k )} ) , & Eq . ( 10 ) \\ {f}_{j}^{L} ( {\hat{W}}^{( N )} ) = {Ω}_{j , :}^{( N - 1 )} \hat{W} {Φ}^{( N - 1 )} ( x ) + {\sum }_{k = N}^{K} {Ω}_{j , :}^{( k )} ( {b}^{( k )} + {Θ}_{: , j}^{( k )} ) , \\ where \\ {Λ}_{j , :}^{( k - 1 )} = \{ \begin{matrix}{e}_{j}^{⊤} & if k = K + 1 , \\ {Λ}_{j , :}^{( k )} ⊙ {λ}_{j , :}^{( k - 1 )} & if k = N , \\ ( {Λ}_{j , :}^{( k )} {W}^{( k )} ) ⊙ {λ}_{j , :}^{( k - 1 )} & otherwise . \end{matrix} \\ {Ω}_{j , :}^{( k - 1 )} = \{ \begin{matrix}{e}_{j}^{⊤} & if k = K + 1 , \\ {Ω}_{j , :}^{( k )} ⊙ {ω}_{j , :}^{( k - 1 )} & if k = N , \\ ( {Ω}_{j , :}^{( k )} {W}^{( k )} ) ⊙ {ω}_{j , :}^{( k - 1 )} & otherwise . \end{matrix} & Eq . ( 11 )\end{matrix}$$

Here the matrices λ^{(k)}, ω^{(k)}, Δ^{(k)}, Θ^{(k)} are functions of the linear bounding parameters {α_{L,i}^{(k)}, α_{U,i}^{(k)}} and {β_{L,i}^{(k)}, β_{U,i}^{(k)}} on each neuron i at layer k:

$${λ}_{j , i}^{( k )} = \{ \begin{matrix}{α}_{U , i}^{( k )} & if k \neq N - 1 , {Λ}_{j , :}^{( k + 1 )} {W}_{: , i}^{( k + 1 )} \geq 0 , \\ {α}_{L , i}^{( k )} & if k \neq N - 1 , {Λ}_{j , :}^{( k + 1 )} {W}_{: , i}^{( k + 1 )} < 0 , \\ 1 & if k = N - 1. \end{matrix} \\ {ω}_{j , i}^{( k )} = \{ \begin{matrix}{α}_{L , i}^{( k )} & if k \neq N - 1 , {Ω}_{j , :}^{( k + 1 )} {W}_{: , i}^{( k + 1 )} \geq 0 , \\ {α}_{U , i}^{( k )} & if k \neq N - 1 , {Ω}_{j , :}^{( k + 1 )} {W}_{: , i}^{( k + 1 )} < 0 , \\ 1 & if k = N - 1. \end{matrix} \\ {Δ}_{i , j}^{( k )} = \{ \begin{matrix}{β}_{U , i}^{( k )} & if k \neq N - 1 , {Λ}_{j , :}^{( k + 1 )} {W}_{: , i}^{( k + 1 )} \geq 0 , \\ {β}_{L , i}^{( k )} & if k \neq N - 1 , {Λ}_{j , :}^{( k + 1 )} {W}_{: , i}^{( k + 1 )} < 0 , \\ 0 & if k = N - 1. \end{matrix} \\ {Θ}_{i , j}^{( k )} = \{ \begin{matrix}{β}_{L , i}^{( k )} & if k \neq N - 1 , {Ω}_{j , :}^{( k + 1 )} {W}_{: , i}^{( k + 1 )} \geq 0 , \\ {β}_{U , i}^{( k )} & if k \neq N - 1 , {Ω}_{j , :}^{( k + 1 )} {W}_{: , i}^{( k + 1 )} < 0 , \\ 0 & if k = N - 1. \end{matrix}$$

where ⊙ is the Hadamard product and eⱼ ∈ [symbol] ⁿ^{_{K}} is a j-th basis vector. The proof for this analysis (theorem) on the input perturbation can be adapted to weight perturbation in this instance, where fⱼ(Ŵ^{(N)})≤fⱼ^{U,K-1}(Ŵ^{(N)})≤fⱼ^{U,K-2}(Ŵ^{(N)}(≤ . . . ≤fⱼ^{U,N+1}(Ŵ^{(N)})=\tilde{W}ⱼ^{(N+1)}σ(Ŵ^{(N)}Φ^{(N-1)}+b^{(N)}). The derivation of Λ_{j,:}^{(k-1)}, Ω_{j,:}^{(k-1)} from layers N+1 to K−1 is hence the same except for the N-th layer. For N-th layer, since the perturbation is now on Ŵ^{(N)} rather than x, let Λ_{j,:}^{(N-1)}=Λ_{j,:}^{(N)}⊙λ_{j,:}^{(N-1)}. By using the same technique to decompose σ(y) by the inequality (10) with associated sign of the equivalent matrix \tilde{W}_{j,:}^{(N+1)}, the final upper bound Eq. (10) is obtained. The lower bound fⱼ^{L}(Ŵ^{(N)}) is derived in the same manner.

In one embodiment, based on Eqs. (10) and (11), the global output bounds γⱼ^{U} and γⱼ^{L} are derived, which are constants, determined by Eq. (5). Since fⱼ^{L} and fⱼ^{U} are two linear functions and Ŵ ∈ [symbol] (W, ∈) is a convex norm constraint, the optimal value of Eq., (5) is obtained by Holder's inequalities:

γⱼ^{U}=∈ ∥Λ_{j,:}^{(N-1)} ∥₁·∥Φ^{(N-1)}(x)∥_{q}+Λ_{j,:}^{(N-1)}W^{(N)}Φ^{(N-1)}(x)+Σ_{k=N}^{K} Λ_{j,:}^{(k) (}b^{(k)}+Δ_{:.j}^{(k)}), Eq. (12)

γⱼ^{L}=−∈ ∥Ω_{j,:}^{(N-1)} ∥₁·∥Φ^{(N-1)}(x)∥_{q}+Ω_{j,:}^{(N-1)}W^{(N)}Φ^{(N-1)}(x)+Σ_{k=N}^{K} Ω_{j,:}^{(k)}(b^{(k)}+Θhd :,j^{(k)}), Eq. (13)

where 1/q=1−1/p. As γⱼ^{U} and γ_{c}^{L} are monotonically increasing and decreasing with respect to ∈, respectively, Eq. (6) is processed by the bisection search over ∈, which renders the certified lower bound on network's robustness against weight perturbation.

One or more embodiments are distinguishable from adversarial robustness against input perturbation in that f is a function of perturbed weight matrix Ŵ^{(N)} bounded by two linear functions fⱼ^{U}(Ŵ^{(N)}), fⱼ^{L}(Ŵ^{(N)}) as opposed to a function of perturbed input x. Once the neuron's activation are linearly bounded, the bounds are computed layer-by-layer with the analysis (or theorem) described above. In some embodiments, the results can be directly extended to convolutional layers.

In some embodiments, when there exists multi-layer weights perturbations, deriving the certified lower bound becomes much more involved as the weight perturbations will be coupled across layers. However, computing a layer-wise bound for each neuron is still possible—previous single-layer results are integrated with interval bound propagation as demonstrated below. Without loss of generality, assume that the weight matrices at the S-th layer and the N-th layer are both perturbed with S<N<K. Eqs. (12) and (13) can be directly used to compute the perturbation bounds at each neuron of layer S by viewing the N−1-th layer as the output layer. For N−1≤i≤K, the following is obtained: \hat{l}ᵣ⁽ⁱ⁾≤Φᵣ⁽ⁱ⁾≤ûᵣ⁽ⁱ⁾, where ûᵣ⁽ⁱ⁾=σ(uᵣ⁽ⁱ⁾), \hat{l}ᵣ⁽ⁱ⁾=σ(lᵣ⁽ⁱ⁾). Let k=N−1, p=∞ and q=1, then:
if i=k,

$${u}_{j}^{( i + 1 )} = \vert {W}_{j , :}^{( i + 1 )} \vert \frac{{\hat{u}}^{( i )} - {\hat{i}}^{( i )}}{2} + {W}_{j , :}^{( i + 1 )} \frac{{\hat{u}}^{( i )} + {\hat{i}}^{( i )}}{2} + {b}_{j}^{( k + 1 )} + ϵ {‖ \frac{{\hat{u}}^{( i )} - {\hat{i}}^{( i )}}{2} ‖}_{q} + ϵ {‖ \frac{{\hat{u}}^{( i )} + {\hat{i}}^{( i )}}{2} ‖}_{q}$$

$${l}_{j}^{( i + 1 )} = - \vert {W}_{j , :}^{( i + 1 )} \vert \frac{{\hat{u}}^{( i )} - {\hat{i}}^{( i )}}{2} + {W}_{j , :}^{( i + 1 )} \frac{{\hat{u}}^{( i )} + {\hat{i}}^{( i )}}{2} + {b}_{j}^{( k + 1 )} - ϵ {‖ \frac{{\hat{u}}^{( i )} - {\hat{i}}^{( i )}}{2} ‖}_{q} + ϵ {‖ \frac{{\hat{u}}^{( i )} + {\hat{i}}^{( i )}}{2} ‖}_{q}$$

if i>k,

$${u}_{j}^{( i + 1 )} = \vert {W}_{j , :}^{( i + 1 )} \vert \frac{{\hat{u}}^{( i )} - {\hat{i}}^{( i )}}{2} + {W}_{j , :}^{( i + 1 )} \frac{{\hat{u}}^{( i )} + {\hat{i}}^{( i )}}{2} + {b}_{j}^{( i + 1 )}$$

$${l}_{j}^{( i + 1 )} = - \vert {W}_{j , :}^{( i + 1 )} \vert \frac{{\hat{u}}^{( i )} - {\hat{i}}^{( i )}}{2} + {W}_{j , :}^{( i + 1 )} \frac{{\hat{u}}^{( i )} + {\hat{i}}^{( i )}}{2} + {b}_{j}^{( i + 1 )}$$

and the NN output f(Ŵ^{(s)}, Ŵ^{(N)}) is bounded by lⱼ^{(K)≤f}ⱼ(Ŵ^{(s)}, Ŵ^{(N)})≤uⱼ^{(K)}. For simplicity, the above analysis is presented with a same ∈ and without bias perturbation, but the analysis is extendible to the case where ∈ᵢ associated to the i-th layer and when biases b are perturbed.

For one embodiment, the problem of weight quantization, commonly used for NN compression, is revisited through the lens of certificated robustness against weight perturbation.

In some embodiments, a unified quantization framework with a perturbation certificate is employed by leveraging alternating direction method of multipliers (ADMM). Given a finite number of bits, the goal is to discretize a ML model's weights while preserving its accuracy. In one embodiment, at dₖ-bit quantization of layer k, 1 bit is used to represent a zero value, and the remaining dₖ−1 bits are used to represent at most 2^{d}^{ₖ}⁻¹ different values with distance q^{(k)}. The quantization of continuous weights W^{(k)}=C^{(k)} is given by

Ŵ^{(k)} ∈ {−2^{d}^{ₖ}⁻²q^{(k)}, . . . , −2q^{(k)}, −q^{(k)}, 0, q^{(k)}, 2q^{(k)}, . . . , 2^{d}^{ₖ}⁻²q^{(k)}}, ∀k ∈ [K] Eq. (14)

The notation of perturbed weights Ŵ^{(k)} is used to represent the weights after quantization. It should be noted that the set of quantized values in Eq. (14) can easily be encoded using binary bits and implemented in computing hardware. For example, by storing q^{(k), {-}2q^{(k)}, −q^{(k)}, 0, q^{(k)}, 2_{q}^{(k)}} can be expressed as {−2, −1,0,1,2}. Given the training loss f and the number of bits {dₖ}, the problem of weight quantization determines {q^{(k)}, Ŵ^{(k)}} by solving the optimization problem

minimize_{{q}_{^{(k)}}_{,Ŵ}_{^{(k)}}_{}}f({Ŵ^{(k)}}), subject to Eq. (14). Eq. (15)

Note that a quantized NN may suffer from the generalization issue. However, any weight perturbation within the certified region found by the analysis above (or theorem) will not cause misclassification. Thus, from the perspective of weight perturbation, one can integrate the certified region with Eq. (15) to reduce the generalization error caused by quantization. The resulting quantization problem is referred to as certified weight quantization, which is given by

$${minimize}_{\{ {q}^{( k )} , {\hat{W}}^{( k )} \}} f ( \{ {\hat{W}}^{( k )} \} ) \\ subject to Eq . ( 14 ) , {‖ {\hat{W}}^{( k )} - {C}^{( k )} ‖}_{∞} \leq {ϵ}_{c}^{( k )} , ∀ k , \qquad Eq . ( 16 )$$

where ∈_{c}^{(k)} is a threshold chosen by the radius of the certified perturbation region with respect to continuous weights C^{(k)} at layer k. Given a training sample x, the solution to Eq. (6) provides ∈_{c}^{(k)}(x). The sample-independent threshold ∈_{c}^{(k)} can then be set as the average or other percentiles of {∈_{c}^{(k)}(x)} over multiple training samples. Example experiments show that the empirical improvement on the generalization error of quantized NNs is significant by incorporating the certification constraints on weight perturbation.

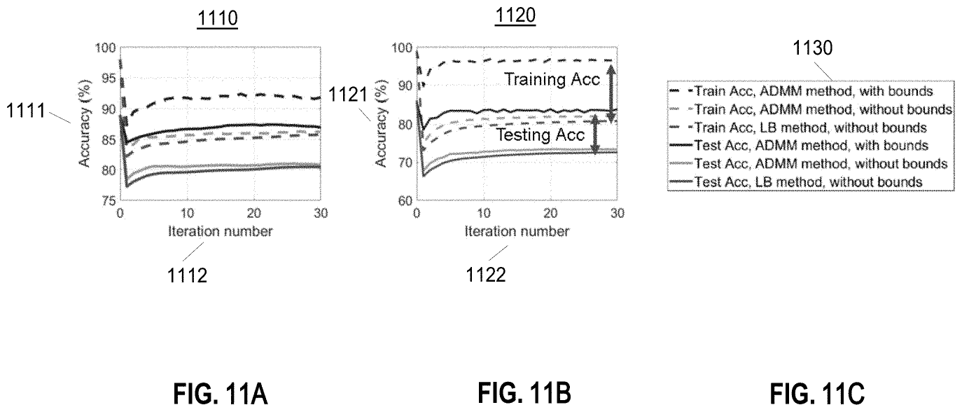

At the first glance, one may think that Eq. (16) would yield worse training loss compared to Eq. (15), since the former has additional constraints. However, due to non-convexity, it is difficult to solve Eqs. (15) and (16) at the global optimality. This is different when comparing a local optimal solution to Eq. (16) with a local optimal solution to Eq. (15). Suppose that training and testing samples obey the same underlying data distribution, then in one embodiment the robustness certificate can drive the designed sub-optimal quantizer toward better generalization capability. Indeed, experiments show that the introduction of certificate constraints reduces both training and generalization errors (see, e.g., FIGS. 11A-C).

Some embodiments provide for certified weight quantization via ADMM. Upon defining Ŵ^{k}=q^{(k)}\hat{V}^{k}, Eq. (16) can be rewritten as

$${minimize}_{\{ {q}^{( k )} , {\hat{V}}^{( k )} \}} f ( \{ {q}^{( k )} {\hat{V}}^{( k )} \} ) \\ subject to {\hat{V}}^{( k )} ∈ {𝒟}^{( k )} , ∀ k , \\ {‖ {q}^{( k )} {\hat{V}}^{k} - {C}^{( k )} ‖}_{∞} \leq {ϵ}_{c}^{( k )} , ∀ k \qquad Eq . ( 17 )$$

where [symbol] ^{(k)}:={−2^{d}^{ₖ}⁻², . . . , −2, −1,0,1,2, . . . , 2^{d}^{ₖ}⁻²}. Note that solving Eq. (17) is challenging since certificate constraints involve bilinear terms {q^{(k)}\hat{V}^{(k)}}. In one embodiment, ADMIVI is used to decompose Eq. (15) into a sequence of sub-equations that are more easily solved. However, the conventional approach suffers from two issues: a) the ADMM formulation ignores the splitting with respect to q^{(k)}, b) an internal alternating optimization method is required for solving one of the sub-equations in ADMM. To circumvent these issues, in one embodiment a different ADMM-based equation formulation and optimization process (or algorithm) is employed. In one embodiment, an auxiliary variable Ĝ^{k} is introduced together with Ĝ^{k}=\hat{V}^{k} and Eq. (17) is reformulated by lending itself to the application of ADMM,

$${minimize}_{\{ {q}^{( k )} , {\hat{V}}^{( k )} , {\hat{G}}^{( k )} \}} f ( \{ {q}^{( k )} {\hat{G}}^{( k )} \} ) + {𝒥}_{1} ( \{ {\hat{V}}^{( k )} \} ) + {𝒥}_{2} ( \{ {q}^{( k )} {\hat{G}}^{( k )} \} ) \\ subject to {\hat{G}}^{( k )} = {\hat{V}}^{( k )} , ∀ k , \qquad Eq . ( 18 )$$

where J₁ and J₂ are indicator functions encoding the constraints a) \hat{V}^{(k)} ∈ D^{(k)} for all k, and b) ∥q^{(k)}Ĝ^{(k)}−C^{(k)} ∥_{∞}≤∈_{c}^{(k)} for all k.

A key difference from the ADMM formulation in conventional techniques is that the auxiliary variable is imposed with respect to \hat{V}^{(k)} rather than Ŵ^{(k)} so that the variable q^{(k)} is explicitly included in some embodiments formulation. In one embodiment, the augmented Lagrangian function of Eq. (18) is introduced that will be alternatively minimized in ADMM,

$$ℒ ( \{ {q}^{( k )} \} , \{ {\hat{V}}^{( k )} \} , \{ {\hat{G}}^{( k )} \} , \{ {\hat{U}}^{( k )} \} ) = f ( \{ {q}^{( k )} {\hat{G}}^{( k )} \} ) + {𝒥}_{1} ( \{ {\hat{V}}^{( k )} \} ) + {𝒥}_{2} ( \{ {q}^{( k )} {\hat{G}}^{( k )} \} ) + {\sum }_{k = 1}^{K} {( {\hat{U}}^{( k )} )}^{T} ( {\hat{G}}^{( k )} - {\hat{V}}^{( k )} ) + \frac{ρ}{2} {\sum }_{k = 1}^{K} {‖ {\hat{G}}^{( k )} - {\hat{V}}^{( k )} ‖}_{F}^{2} , \qquad Eq . ( 19 )$$

where ρ>0 is a regularization parameter, Û^{(k)} are Lagrangian multipliers with respect to equality constraints of Eq. (18), and ∥⋅∥_{F} denotes the Frobenius norm. For ease of notation, let Ĝ, q, \hat{V} and U denote the set of variables {Ĝ^{(k)}}, {q^{(k)}}, {\hat{V}^{(k)}} and {Û^{(k)}}. The main computations of ADMM are alternatively minimizing Eq. (19) over two blocks of variables, Ĝ and {q, \hat{V}}. That is, ADMM at the t-th iteration is given by

Ĝ(t+1)=arg min_{Ĝ} [symbol] (q(t), \hat{V}(t), Ĝ,U(t)), Eq. (20)

{q(t+1), \hat{V}(t+1)}=arg min_{q,\hat{V}} [symbol] (q, \hat{V}, Ĝ(t+1), U(t)), Eq. (21)

where U(t+1)=U(t)+ρ(Ĝ(t+1)−\hat{V}(t+1)), and ADMM is initialized with specified q(0), \hat{V}(0) and U(0). It is noted that Eq. (21) is decomposable with respect to q and \hat{V}; see equivalent ADMM steps below.

In some embodiments, it is proposed that the ADMM sub-equations (Eqs. (20) and (21)) can be equivalently transformed into a) Ĝ-minimization step, b) q-minimization step and c) \hat{V}-minimization step. That is,

Ĝ-minimization step: Ĝ(t+1) in Eq. (20) is given by the solution of the problem

$${minimize}_{\hat{G}} f ( \hat{G} ; q ( t ) ) + \frac{ρ}{2} {‖ \hat{G} - A ‖}_{F}^{2} \\ subject to ( 1 \text{/} {q}^{( k )} ) {\breve{D}}^{( k )} \leq {\hat{G}}^{( k )} \leq ( 1 \text{/} {q}^{( k )} ) {\hat{D}}^{( k )} , ∀ k , \qquad Eq . ( 22 )$$

where f(Ĝ; q(t)) represents f with respect to variables Ĝ under given values q(t), Ď^{(k)}:=C^{(k)}−∈_{c}^{(k)}I, and \hat{D}^{(k)}:=∈_{c}^{(k)}I+C^{(k)}.

q-minimization step: q(t+1) in Eq. (21) is given by the solution of the problem

$${minimize}_{q} f ( q ; \hat{G} ( t + 1 ) ) \\ subject to max \{ {\hat{a}}_{1}^{( k )} , {\hat{a}}_{2}^{( k )} \} \leq {q}^{( k )} \leq min \{ {\breve{a}}_{1}^{( k )} , {\breve{a}}_{2}^{( k )} \} , ∀ k . \qquad Eq . ( 23 )$$

Let I_{k,+} and I_{k,-} denote the index set of positive and negative elements in Ĝ^{(k)}(t+1), respectively. And let 1[X]_{I} denote the sub-matrix of X selected by the index set I, and ⋅/⋅ and max{⋅} denote the element-wise division and maximum operation, respectively. Then \hat{α}₁^{(k)}, \hat{α}₂^{(k)}, \hat{α}₁^{(k)}, and \check{α}₂^{(k)} in (??) are given by

\hat{α}₁^{(k)}:=max{[Ď^{(k)}]_{I}_{_{k,+}}/[Ĝ^{(k)}(t+1)]_{I,}_{_{k,+}}},
\hat{α}₂^{(k)}:=max{[\hat{D}^{(k)}]_{I}_{_{k,−}}/[Ĝ^{(k)}(t+1)]_{I,}_{_{k,−}}},
\check{α}₁^{(k)}:=min{[\hat{D}^{(k)}]_{I}_{_{k,+}}/[Ĝ^{(k)}(t+1)]_{I,di k,+}},
\check{α}₂^{(k)}:=min{[Ď^{(k)}]_{I}_{_{k,−}}/[Ĝ^{(k)}(t+1)]_{I,di k,-}},

\hat{V}-minimization step: \hat{V}(t+1) in Eq. (21) is given by

$${\hat{V}}_{ij}^{( k )} ( t + 1 ) = \{ \begin{matrix}{B}_{ij} & {B}_{ij} ∈ [ - {2}^{{d}_{k} - 2} , {2}^{{d}_{k} - 2} ] \\ - {2}^{{d}_{k} - 2} & {B}_{ij} < - {2}^{{d}_{k} - 2} \\ {2}^{{d}_{k} - 2 } & {B}_{ij} > {2}^{{d}_{k} - 2} , \end{matrix} \qquad Eq . ( 24 )$$

where \hat{V}ᵢⱼ^{(k)}(t+1) denotes the (i,j)-th element of \hat{V}^{(k)}(t+1), x represents the nearest integer to x, and B:=Ĝ(t+1)−(1/ρ)U(t). Here, each sub-equation can be efficiently handled by standard optimization solvers. In Eqs. (22)-(23), since the constraint sets are simple box constraints, projected gradient descent methods can be used to find solutions Ĝ(t+1) and q(t+1). In Eq. (24), the closed-form expression of the solution \hat{V}(t+1) is employed. It should also be noted that ADMM is convergent and reaches a sub-linear convergence rate for nonconvex and nonsmooth stochastic optimization.

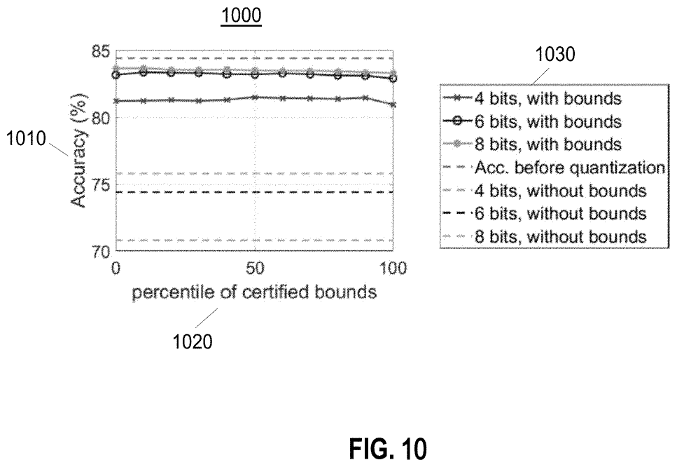

FIG. 10 illustrates a graph 1000 for testing accuracy of quantized 8-layer MLP on the street view house numbers (SVHN) dataset versus certification constraints, according to one embodiment. In graph 1000, accuracy 1010 (in percentage) is depicted versus percentile of certified bounds 1020 with legend 1030. SVHN is a real-world image dataset for developing ML and object recognition algorithms with minimal requirement on data preprocessing and formatting. SVHN is similar in “flavor” to the Modified National Institute of Standards and Technology (MNIST) database (e.g., the images are of small cropped digits), but incorporates an order of magnitude more labeled data (over 600,000 digit images) and comes from a significantly harder, unsolved, real world problem (recognizing digits and numbers in natural scene images). The MNIST is a large database (60,000 training images and 10,000 testing images) that includes handwritten digits, and is used for training and testing various image processing systems and ML systems.

In testing one example embodiment, the testing accuracy of quantized 8-layer MLP (4, 6, and 8 bits per layer) on SVHN versus the certification constraint parameter chosen by different percentiles of certified weight perturbation lower bounds over 100 training images is shown in graph 1000. The results shown in graph 1000 demonstrate the effectiveness of one embodiment under two applications: a) weight quantization described described above and b) model robustness against fault sneaking attack. To align with the theoretical results, the testing is performed under MLP ML models for various numbers of layers. The performance of the embodiment is evaluated under 4 datasets, MNIST, MNIST-fashion (similar to MNIST, and consists of a training set consisting of 60,000 examples belonging to 10 different classes and a test set of 10,000 examples; each training example is a gray-scale image, 28×28 in size), SVHN, and Canadian Institute For Advanced Research-10 (CIFAR-10) (the CIFAR-10 dataset consists of 60,000 32×32 color images in 10 classes, with 6,000 images per class; there are 50,000 training images and 10,000 test images.).

In one example embodiment, the testing accuracy results in graph 1000, MLP models of 2, 4, 6, 8 and 10 layers were considered, each of which is quantized using 4, 6, and 8 bits. The testing accuracy of the quantized 8-layer MLP on SVHN versus the choice of the certification constraint parameter ∈_{c}^{(k)} of Eq. (16). In the testing, ∈_{c}^{(k)} is set as a percentile of certified robustness bounds Eq. (6) over 100 training images. For comparison, the performance of weight quantization is presented by solving Eq. (15) without imposing certification constraints. It can be seen that the use of certification bounds significantly boosts the testing accuracy of quantized NNs (around a 10% improvement) and approaches the testing accuracy without quantization.

Moreover, it is observed that the improved performance is insensitive to the choice of ∈_{c}^{(k)} except a slight degradation when ∈_{c}^{(k)} is greater than the 90 percentile of weight certification bounds. This is not surprising since the performance of weight quantization without imposing certification constraints is worst, corresponding to the extreme case ∈_{c}^{(k)}→∞. In the following testing, unless specified otherwise, ∈_{c}^{(k)} is chosen as the 50th percentile of certified robustness bounds. Additional results on CIFAR-10 and other model architectures are provided in Table 1.

TABLE 1

| | | | | Acc after quantization (%) | | | | |
|---|---|---|---|---|---|---|---|---|
| | | | | 25 percentile | 50 percentile | 75 percentile | mean | |
| | number of | bits per | original | certified | certified | certified | certified | no |
| dataset | layers | layer | Acc (%) | bounds | bounds | bounds | bounds | certification |
| SVHN | 2 | 4 | 83.8 | 73.8 | 72.9 | 71.5 | 72.4 | 61 |
| | | 6 | 83.8 | 80.5 | 80.6 | 80.7 | 80.35 | 68 |
| | | 8 | 83.8 | 81.2 | 81.5 | 81.4 | 81.3 | 70 |
| | 4 | 4 | 84.1 | 77.6 | 76.9 | 75.5 | 75.9 | 62.8 |
| | | 6 | 84.1 | 82.6 | 82.3 | 81.8 | 82.5 | 69 |
| | | 8 | 84.1 | 82.8 | 82.4 | 81.9 | 82.3 | 71.5 |
| | 6 | 4 | 84.5 | 81 | 80.7 | 80.7 | 80.8 | 68.8 |
| | | 6 | 84.5 | 83.1 | 83 | 83.1 | 82.9 | 72 |
| | | 8 | 84.5 | 83.5 | 83.4 | 83.4 | 83.3 | 74.5 |
| | 8 | 4 | 84.4 | 81.2 | 81.5 | 81.5 | 81.4 | 70.8 |
| | | 6 | 84.4 | 83.3 | 83.1 | 83.2 | 83.2 | 74.4 |
| | | 8 | 84.4 | 83.6 | 83.5 | 83.4 | 83.5 | 75.8 |
| | 10 | 4 | 84.6 | 81.3 | 81.4 | 81.2 | 81.2 | 75.7 |
| | | 6 | 84.6 | 83.8 | 83.9 | 83.8 | 83.7 | 76.3 |
| | | 8 | 84.6 | 84.2 | 84.2 | 84.3 | 84.1 | 77 |
| CIFAR-10 | 2 | 4 | 56.9 | 50.7 | 50.6 | 49.8 | 50.3 | 25.6 |
| | | 6 | 56.9 | 52.8 | 51.6 | 51.9 | 51.8 | 31.1 |
| | | 8 | 56.9 | 53.2 | 52.6 | 52.3 | 52.9 | 35.6 |
| | 4 | 4 | 57.2 | 51.2 | 51 | 51.2 | 51 | 43.2 |
| | | 6 | 57.2 | 55.4 | 55.4 | 55.3 | 55.4 | 48 |
| | | 8 | 57.2 | 56.2 | 56.1 | 56.1 | 56 | 49.3 |
| | 6 | 4 | 58.2 | 52.1 | 52.2 | 51.8 | 52.1 | 46.7 |
| | | 6 | 58.2 | 56.5 | 56.4 | 56.3 | 56.3 | 50.8 |
| | | 8 | 58.2 | 57.4 | 57.5 | 57.1 | 57.3 | 51.1 |
| | 8 | 4 | 58 | 52.8 | 53 | 52.8 | 52.7 | 48.7 |
| | | 6 | 58 | 56.3 | 56.2 | 56.1 | 56.2 | 51 |
| | | 8 | 58 | 57.4 | 57.3 | 57.2 | 57.2 | 51.6 |
| | 10 | 4 | 58.1 | 53.6 | 53.6 | 53.5 | 53.6 | 48.8 |
| | | 6 | 58.1 | 56.5 | 56.5 | 56.4 | 56.4 | 51.3 |
| | | 8 | 58.1 | 57.7 | 57.6 | 57.6 | 57.6 | 51.6 |

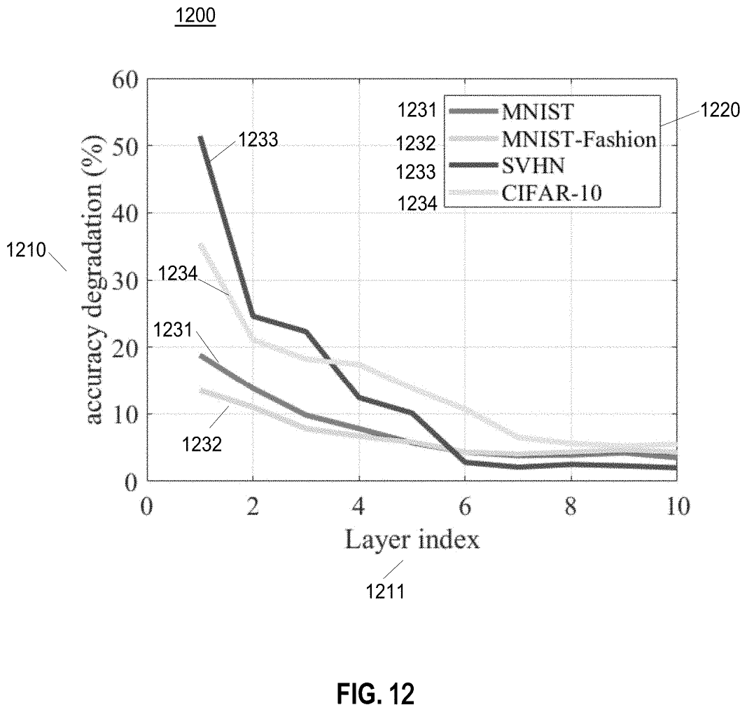

It was shown in conventional systems that slightly perturbing model weights at a single layer is capable of misclassifying a specific set of natural images toward target labels but keeping classification of unspecified input images intact. The corresponding threat model is called fault sneaking attack (FSA). It is worth mentioning that such an attack is commonly performed at deep layers of a NN due to its stealthiness requirement. Table 1 shows the original accuracy (Acc), Acc after FSA, certified lower bound on weight perturbation, and the [symbol] _{∞} norm of weight perturbations caused by FSA. It can be seen that the certified lower bound decreases as the layer index decreases since the linear bound approximation becomes looser when it needs to propagate over more layers prior to the output layer. Moreover, the certified lower bound shares the same pattern of FSA against the layer index. This indicates the intrinsic robustness of networks against FSA: a shallower layer is more vulnerable to FSA, which is also verified in graph 1200 (FIG. 12).

TABLE 2

| dataset | layer index | 7 | 8 | 9 | 10 |
|---|---|---|---|---|---|
| MINST | original Acc (%) | 97.8 | 97.8 | 97.8 | 97.8 |
| | Acc after attack (%) | 94 | 93.9 | 93.6 | 94.3 |
| | certified bound | 2 × 10⁻⁶ | 2.6 × 10⁻⁵ | 0.0003 | 0.0083 |
| | attack perturbation | 0.042 | 0.048 | 0.052 | 0.073 |
| MNIST-Fashion | original Acc (%) | 88.6 | 88.6 | 88.6 | 88.6 |
| | Acc after attack (%) | 84.6 | 84.3 | 84.0 | 84.3 |
| | certified bound | 2 × 10⁻⁶ | 2.4 × 10⁻⁵ | 0.00033 | 0.0117 |
| | attack perturbation | 0.025 | 0.0306 | 0.0351 | 0.11 |
| SVHN | original Acc (%) | 82.6 | 82.6 | 82.6 | 82.6 |
| | Acc after attack (%) | 80.5 | 80.1 | 80.3 | 80.6 |
| | certified bound | 4 × 10⁻⁶ | 5.6 × 10⁻⁵ | 0.0008 | 0.035 |
| | attack perturbation | 0.023 | 0.027 | 0.036 | 0.102 |
| CIFAR-10 | original Acc (%) | 56.7 | 56.7 | 56.7 | 56.7 |
| | Acc after attack (%) | 50.2 | 51.1 | 51.5 | 51.2 |
| | certified bound | 4 × 10⁻⁶ | 5 × 10⁻⁵ | 0.0007 | 0.027 |
| | attack perturbation | 0.036 | 0.04 | 0.056 | 0.15 |

FIG. 11A shows a graph 1110 for training/testing accuracy of quantization with/without certification constraints for the Fashion Modified National Institute of Standards and Technology (MNIST) database (MNIST-Fashion), according to one embodiment. Graph 1110 includes accuracy (%) 1111 versus iteration number 1112. FIG. 11B shows a graph 1120 for training/testing accuracy of quantization with/without certification constraints for the SVHN dataset, according to one embodiment. Graph 1120 includes accuracy (%) 1121 versus iteration number 1122. FIG. 11C shows a legend 1130 for the graphs of FIGS. 11A-B, according to one embodiment. One embodiment NN model processing is compared with a ADMM-based low-bits (LB) quantization method in terms of training/testing accuracy versus ADMM iterations under datasets MNIST-fashion and SVHN. The LB method was designed to solve Eq. (15) without introducing certification constraints. All the methods are initialized from the same pre-trained model of continuous weights. It can be seen from training accuracy that the embodiment tested converges to a better local optimal solution than the LB method even in the absence of certification constraints. When information on certified robustness bounds is considered, both training and testing accuracy are significantly improved, consistent with results in graph 1000 (FIG. 10) and Table 2.

FIG. 12 shows a graph 1200 for test accuracy degradation after perturbing each layer of a model using a fault injection attack, according to one embodiment. In graph 1200, accuracy degradation (%) 1210 is shown versus layer index 1211 using the legend 1220. In the FSA, errors of 4 images (randomly chosen from a given dataset, MNIST 1231/MNIST-Fashion 1232/SVHN 1233/CIFAR-10 1234) are injected with random target labels for a 10-layer MLP. Graph 1200 demonstrates the testing accuracy degradation (compared to the accuracy of the original model) against the layer index attacked by FSA. As can be seen in graph 1200, attacking the shallow layers introduces larger testing accuracy discrepancy. Thus, to keep the attack stealthy, only the deeper layers 7-10 are perturbed. In one embodiment, the multi-layer perturbation based certificate processing is performed over the same 4 images used to inject errors by the attack. The procedure of attack and certification is performed over 100 random trials and the averaged results of the certified bounds and the largest weight perturbation caused by FSA are reported shown in Table 1.

FIG. 13 illustrates a block diagram of a process 1300 for robustness-aware quantization processing for NNs against weight perturbations, according to one embodiment. In one embodiment, in block 1310, process 1300 receives, by a computing device (from computing node 10, FIG. 1, hardware and software layer 60, FIG. 2, processing system 300, FIG. 3, system 400, FIG. 4, system 500, FIG. 5, etc.) an NN for optimization. In block 1320, process 1300 further determines, by the computing device, on a region by region basis one or more robustness bounds for weights within the NN, the robustness bounds indicating values beyond which the NN generates an erroneous output upon performing an adversarial attack on the NN. In block 1330, process 1300 further provides averaging, by the computing device, of all robustness bounds on the region by region basis. In block 1340, process 1300 additionally provides optimizing, by the computing device, weights for adversarial proofing the NN based at least in part on the averaged robustness bounds.

In one embodiment, process 1300 may further include the feature that the robustness bounds include a certified weight perturbation region such that the NN maintains a prediction accuracy upon weight parameter perturbation occurring within the certified weight perturbation region.

In one embodiment, process 1300 may additionally include the feature that averaging further includes: determining, by the computing device, a certified weight perturbation region for multiple inputs such that the NN maintains a prediction accuracy upon weight parameter perturbation occurring within the certified weight perturbation region.

In one embodiment, process 1300 may still additionally include the feature of determining, by the computing device, a maximum perturbation radius such that an optimal objective value is positive.

In one embodiment, process 1300 may yet additionally include the feature of applying, by the computing device, certificate-aware weight perturbation constraints based on the averaged robustness bounds in quantization design of the NN.

In one embodiment, process 1300 may further include the feature of training, by the computing device, the NN using ADMM and incorporating the certificate-aware weight perturbation constraints. In one embodiment, process 1300 may include the feature that the NN is a quantized DNN.

In one embodiment, process 1300 may still further include the feature of discretizing, by the computing device, model weights for the NN based on a finite number of bits while preserving the machine learning model output prediction accuracy.

In one embodiment, process 1300 may include the feature of propagating, by the computing device, the averaged robustness bounds throughout a plurality of neurons in the NN.

In some embodiments, the features described above contribute to the advantage of efficient processing for computing a certified robustness bound, in terms of a certified weight perturbation region, within which the weight-perturbed networks will not make erroneous outputs. The embodiments are useful in both non-adversarial and adversarial environments. The features further contribute to the advantage of, for non-adversarial NNs, a design of weight quantization scheme that leverages the knowledge on certified robustness. The embodiments significantly improve the generalization ability of quantized NNs. For adversarial environments, some features contribute to the advantage of providing a robustness indicator of NNs when facing weight-perturbation based adversarial attacks.

One or more embodiments may be a system, a method, and/or a computer program product at any possible technical detail level of integration. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM:), a portable compact disc read-only memory (CD-ROM:), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, he accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of utilizing a computing device to optimize weights within a neural network to avoid adversarial attacks, the method comprising:
receiving, by a computing device, a neural network for optimization;
determining, by the computing device, on a region by region basis one or more robustness bounds for weights within the neural network, the robustness bounds indicating values beyond which the neural network generates an erroneous output upon performing an adversarial attack on the neural network;
averaging, by the computing device, all robustness bounds on the region by region basis; and
optimizing, by the computing device, weights for adversarial proofing the neural network based at least in part on the averaged robustness bounds.

2. The method of claim 1, wherein the robustness bounds comprise a certified weight perturbation region such that the neural network maintains a prediction accuracy upon weight parameter perturbation occurring within the certified weight perturbation region.

3. The method of claim 1, wherein averaging further comprising:
determining, by the computing device, a certified weight perturbation region for multiple inputs such that the neural network maintains a prediction accuracy upon weight parameter perturbation occurring within the certified weight perturbation region.

4. The method of claim 1, further comprising:
determining, by the computing device, a maximum perturbation radius such that an optimal objective value is positive.

5. The method of claim 1, further comprising:
applying, by the computing device, certificate-aware weight perturbation constraints based on the averaged robustness bounds in quantization design of the neural network.

6. The method of claim 5, further comprising:
training, by the computing device, the neural network using alternating direction method of multipliers (ADMM) and incorporating the certificate-aware weight perturbation constraints,
wherein the neural network is a quantized deep neural network.

7. The method of claim 5, further comprising:
discretizing, by the computing device, model weights for the neural network based on a finite number of bits while preserving the machine learning model output prediction accuracy.

8. The method of claim 7, further comprising:
propagating, by the computing device, the averaged robustness bounds throughout a plurality of neurons in the neural network.

9. A computer program product for optimizing weights within a neural network to avoid adversarial attacks, the computer program product comprising a computer readable storage medium having program instructions embodied therewith, the program instructions executable by a processor to cause the processor to:
receive, by the processor, a neural network for optimization;
determine, by the processor, on a region by region basis one or more robustness bounds for weights within the neural network, the robustness bounds indicating values beyond which the neural network generates an erroneous output upon performing an adversarial attack on the neural network;
average, by the processor, all robustness bounds on the region by region basis; and
optimize, by the processor, weights for adversarial proofing the neural network based at least in part on the averaged robustness bounds.

10. The computer program product of claim 9, wherein the robustness bounds comprise a certified weight perturbation region such that the neural network maintains a prediction accuracy upon weight parameter perturbation occurring within the certified weight perturbation region.

11. The computer program product of claim 9, wherein averaging further comprising:
determine, by the processor, a certified weight perturbation region for multiple inputs such that the neural network maintains a prediction accuracy upon weight parameter perturbation occurring within the certified weight perturbation region.

12. The computer program product of claim 9, wherein the program instructions executable by the processor further cause the processor to:
determine, by the processor, a maximum perturbation radius such that an optimal objective value is positive.

13. The computer program product of claim 9, wherein the program instructions executable by the processor further cause the processor to:
apply, by the processor, certificate-aware weight perturbation constraints based on the averaged robustness bounds in quantization design of the neural network.

14. The computer program product of claim 13, wherein the program instructions executable by the processor further cause the processor to:
train, by the processor, the neural network using alternating direction method of multipliers (ADMM) and incorporating the certificate-aware weight perturbation constraints, wherein the neural network is a quantized deep neural network.

15. The computer program product of claim 13, wherein the program instructions executable by the processor further cause the processor to:
discretize, by the processor, model weights for the neural network based on a finite number of bits while preserving the machine learning model output prediction accuracy; and
propagate, by the processor, the averaged robustness bounds throughout a plurality of neurons in the neural network.

16. An apparatus comprising:
a memory configured to store instructions; and
a processor configured to execute the instructions to:
receive a neural network for optimization;
determine on a region by region basis one or more robustness bounds for weights within the neural network, the robustness bounds indicating values beyond which the neural network generates an erroneous output upon performing an adversarial attack on the neural network;
average all robustness bounds on the region by region basis; and
optimize weights for adversarial proofing the neural network based at least in part on the averaged robustness bounds.

17. The apparatus of claim 16, wherein:
the robustness bounds comprise a certified weight perturbation region such that the neural network maintains a prediction accuracy upon weight parameter perturbation occurring within the certified weight perturbation region; and
average all of the robustness bounds further comprising:
determining a certified weight perturbation region for multiple inputs such that the neural network maintains a prediction accuracy upon weight parameter perturbation occurring within the certified weight perturbation region.

18. The apparatus of claim 16, wherein the processor is further configured to execute the instructions to:
determine a maximum perturbation radius such that an optimal objective value is positive; and
apply certificate-aware weight perturbation constraints based on the averaged robustness bounds in quantization design of the neural network.

19. The apparatus of claim 18, wherein the processor is further configured to execute the instructions to:
train the neural network using alternating direction method of multipliers (ADMM) and incorporating the certificate-aware weight perturbation constraints,
wherein the neural network is a quantized deep neural network.

20. The apparatus of claim 18, wherein the processor is further configured to execute the instructions to:
discretize model weights for the neural network based on a finite number of bits while preserving the machine learning model output prediction accuracy; and
propagate the averaged robustness bounds throughout a plurality of neurons in the neural network.
